(19) United States
(12) Patent Application Publication
(10) Pub. No.: US 2026/0196012 A1
(43) Pub. Date: Jul. 9, 2026

(54) COMBINING VISUAL AND TEXTUAL REFERENCES FOR SEMANTIC SEGMENTATION

(71) Applicant: International Business Machines Corporation, Armonk, NY (US)

(72) Inventors: Guillaume Thomas Buthmann, Chuo-ku (JP); Tomoya Sakai, Chuo-ku (JP); HAOXIANG QIU, Chuo-ku (JP); Takayuki Katsuki, Chuo-ku (JP); Daiki Kimura, Chuo-ku (JP)

(21) Appl. No.: 19/011,547

(22) Filed: Jan. 6, 2025

(51) Int. Cl. G06V 10/26; G06F 40/30; G06V 10/74; G06V 10/75; G06V 10/82; G06V 10/94; G06V 20/70

(52) U.S. Cl. CPC G06V 10/26; G06V 10/751; G06V 10/761; G06V 10/82; G06V 10/955; G06V 20/70; G06F 40/30

(57) ABSTRACT

An example operation includes one or more of identifying a set of positions of a target image that correspond to an object to be identified within the target image, the identifying of the set of positions occurring via matching first embeddings of the target image to additional embeddings from a description of the object and from a reference image of a reference object, producing a segmentation prompt from the set of positions, and inputting the segmentation prompt into an image segmentation model so that, in response, the image segmentation model generates as an output a segmentation mask for the object and for the target image.

### BACKGROUND

Few-shot semantic segmentation (FSS) approaches take as input annotated reference images for unseen image classes that a model has not been specifically trained on and enable the detection of these classes in target images. Semantic segmentation labels every single pixel contained in an image by its semantic class. For example, each pixel is labeled as belonging to a particular object class depicted in an image or to a background region in an image. Semantic segmentation tasks help machines distinguish the different object classes and background regions in an image. Semantic segmentation helps determine the specific shapes and boundaries of entities that are depicted/captured in an image. Thus, the present embodiments relate to computer vision that is a type of artificial intelligence. Semantic segmentation models create a segmentation map of an input image. A segmentation map is, essentially, a reconstruction of the original image in which each pixel has been color coded by its semantic class to create segmentation masks. A segmentation mask is simply a portion of the image that has been differentiated from other regions of the image. For example, a segmentation map of a tree in an empty field would likely contain three segmentation masks: one for the tree, one for the ground and one for the sky in the background. Semantic segmentation masks have many various and possible industrial applications, e.g., self-driving cars, detecting defections during manufacturing, detecting defections in concrete structures, etc.

### SUMMARY

One example embodiment provides a computer-implemented method that may include one or more of identifying a set of positions of a target image that correspond to an object to be identified within the target image, the identifying of the set of positions occurring via matching first embeddings of the target image to additional embeddings from a description of the object and from a reference image of a reference object, producing a segmentation prompt from the set of positions, and inputting the segmentation prompt into an image segmentation model so that, in response, the image segmentation model generates as an output a segmentation mask for the object and for the target image.

Another example embodiment provides a computer system that may include a processor set, a set of one or more computer-readable storage media, and program instructions, collectively stored in the set of one or more storage media, that cause the processor set to perform computer operations that may include one or more of identifying a set of positions of a target image that correspond to an object to be identified within the target image, the identifying of the set of positions occurring via matching first embeddings of the target image to additional embeddings from a description of the object and from a reference image of a reference object, producing a segmentation prompt from the set of positions, and inputting the segmentation prompt into an image segmentation model so that, in response, the image segmentation model generates as an output a segmentation mask for the object and for the target image.

A further example embodiment provides a computer program product that may include a set of one or more computer-readable storage media, and program instructions, collectively stored in the set of one or more computer-readable storage media, for causing a processor set to perform computer operations that may include one of more of identifying a set of positions of a target image that correspond to an object to be identified within the target image, the identifying of the set of positions occurring via matching first embeddings of the target image to additional embeddings from a description of the object and from a reference image of a reference object, producing a segmentation prompt from the set of positions, and inputting the segmentation prompt into an image segmentation model so that, in response, the image segmentation model generates as an output a segmentation mask for the object and for the target image.

### BRIEF DESCRIPTION OF THE DRAWINGS

FIG. 1 is a diagram illustrating a computing environment according to an embodiment of the instant solution.

FIG. 2 is a diagram illustrating a parallel pipeline architecture of a text-guided few-shot semantic (FSS) image segmentation process according to an embodiment of the instant solution.

FIG. 3A is a diagram illustrating a process of a text reference pipeline generating a labeled image according to an embodiment of the instant solution.

FIG. 3B is a diagram illustrating a process of an image reference pipeline generating a labeled image according to an embodiment of the instant solution.

FIG. 3C is a diagram illustrating a process of identifying a group of pixels in labeled images output by the text reference and image reference pipelines according to an embodiment of the instant solution.

FIG. 4A is a flow diagram illustrating a method according to examples and features of the instant solution.

FIG. 4B is a flow diagram illustrating a method according to additional examples and features of the instant solution.

FIG. 4C is a flow diagram illustrating a method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

Semantic image segmentation is a computer vision task that assigns a class label to pixels in an image using machine learning. The example embodiments are directed to a few-shot semantic (FSS) image segmentation system which can generate a segmented image of an object that was previously unseen by the model. That is, the FSS image segmentation system of the present disclosure does not need training to identify the object within the image, but rather, uses a reference image and a reference description (text) to achieve image segmentation without training of the model being required for that subject matter area.

However, while FSS methods offer cost and time benefits, these methods sometimes underperform (e.g., are less accurate) in comparison to trained or fine-tuned image segmentation models, particularly when presented with out-of-distribution (OOD) images as reference or target images. One of the reasons for this deficiency is that only a limited amount of information can be obtained from a few reference images, which is sometimes insufficient for the model to generalize across image variations, such as style and shape differences, which are common in OOD images. For example, traditional FSS image segmentation does not rely on text. As a result, traditional FSS image segmentation may suffer from drawbacks including a lack of accuracy.

To overcome these drawbacks, the system described herein uses a combination of a text-based image labeling process and an image-based labeling process. Both labeling processes may be performed in parallel, for example, using parallel processing pipelines, thereby reducing the overall execution time of the process in comparison to performing the processes in sequence.

The text-based image labeling process receives a description of the object to be masked and a target image, and the system converts the description and the target image into a shared embedding space, which the system uses to label the object within the target image. Meanwhile, the image-based labeling process receives a reference image of the object to be masked and a target image, and the system converts the reference image and the target image into a shared embedding space, which the system uses to label the object within the target image.

According to various embodiments, the two labeled images are then merged using a matching process that generates a final labeled image of the target image from a combination of the labeled image of the text-based labeling process and the labeled image of the image-based labeling process. The final labeled image is also referred to herein as a segmentation mask with the pixels of the object being labeled and otherwise isolated from the other pixels in the target image that do not correspond to the object.

Some of the benefits of the text-guided FSS image segmentation system include significantly improved accuracy when it comes to the labeling of the object within the image. The system uses a combination of both text-based image segmentation and image-based image segmentation.

The text-guided few-shot semantic (FSS) image segmentation system described herein may be hosted within a software application, a service, or the like, which may be hosted by a host platform such as a cloud platform, a web server, a database, or the like.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

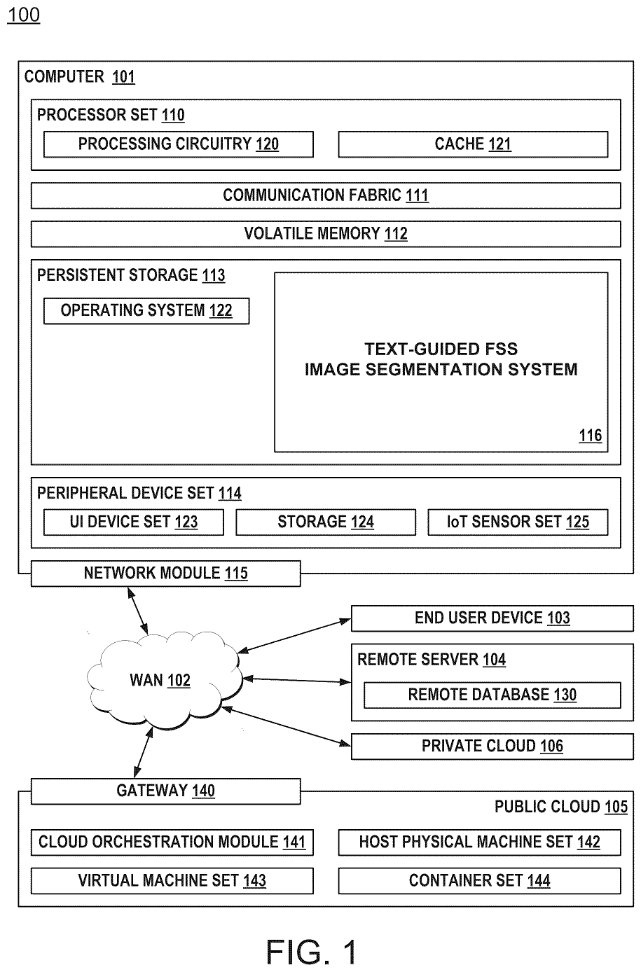

Referring to FIG. 1, computing environment 100 contains an example of an environment for executing at least some of the computer code involved in performing the inventive methods, such as a text-guided FSS image segmentation system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Semantic image segmentation is a computer vision task with many possible industrial applications. For example, semantic image segmentation may be used by self-driving cars, medical imaging, agricultural imaging, defect detection of physical structures, satellite imagery analysis, and the like. Most applications of semantic image segmentation require high performance for reliability purposes. In some cases, the semantic segmentation model must be able to accurately detect rare or unusual classes, which typically requires the semantic segmentation model to undergo a significant amount of training.

Recently, few-shot methods have been introduced into image segmentation, which are capable of detecting classes (objects, etc.) on which the model has not been previously trained, by simply feeding a few examples of labeled data of an object. This drastically reduces the labeling cost. However, such methods can present performance issues on complex classes and out-of-distribution (OOD) data. Infusing linguistic information into computer vision models that work for zero-shot methods as described herein for the various embodiments perform better on unseen categories than models that have been specifically trained or fine-tuned on those categories without even a few examples of labeled data.

The example embodiments are directed to a more comprehensive FSS image segmentation process, which can compute the segmentation mask of unseen novel classes in the target image using a combination of image and text references. The system may receive, as inputs, a target image, a reference image with annotated segmentation masks of the objects, and a text reference that describes the object (for example, the class name). In response, the system may output a segmentation mask of the object within the target image.

By integrating the text reference into the process, the example embodiments increase the amount of information given to the model. Furthermore, because class names are attached to the reference image, there is no additional labeling cost to inject linguistic information. Moreover, even if class names are not available, labeling class names is less costly than creating a mask reference. If the information from one of the two references is not sufficient for the model to output a satisfying mask, it can rely on the other one to improve its prediction. Accordingly, the system can identify pixels of a specific object in a target image using a novel approach that involves using a text description of the object (or label) and a reference image of the object with a mask specifying pixels of the object in the reference image, etc.

The system may receive a target image to be segmented and a reference image, and encodes both the target image and the reference image into embeddings using an image encoder. Furthermore, embedding matching may be performed between the target image embedding and the reference image embedding. The embedding matching results in a set of matched pixels in the target image, which indicate the potential object (or objects) that are to be detected. The term position is used to indicate an area associated with the object. Each matched position is composed of several 2D coordinates, which are close to each other. The embedding matching may also output a confidence value indicating a confidence of each matched position, pixel, etc. The matched positions serve as a prompt for an image segmentation model such as a Segment Anything Model (SAM), which outputs the final segmentation mask.

In addition, the system also includes a parallel pipeline that uses a text reference for image segmentation, which can be executed simultaneously with the reference image pipeline. The text reference pipeline includes a text encoder that can convert the text reference into an embedding within the same space as the image embedding of the target image. The text reference pipeline may also perform embedding matching, which results in a second set of matched pixels in the target image. The two sets of matched pixels can be used to generate two prompts for the SAM model. For example, the system may merge the two prompts (from each pipeline) using a novel position matching process, and generate a final prompt, which is fed into the SAM model.

The SAM can identify objects in images from various input prompts, allowing for a wide range of segmentation tasks without requiring additional training. SAM is a segmentation system with zero-shot generalization to unfamiliar objects and images, without the need for additional training. The SAM may receive, as input, a prompt or prompts, which include foreground points, background points, bounding boxes, masks, and the like. The SAM model can be used for tagging photos, moderating prohibited content, and the like.

Each pipeline outputs pixel positions in the target image, which have the object specified by label and reference. A merging module may select output pixel positions from the text reference pipeline that are close to output pixel positions from the image reference pipeline, or vice versa, and use the selected positions as input to the segmentation model, such as SAM.

Some of the benefits of the system described herein include computing a segmentation mask for unseen novel objects in images with multimodal references for the objects. For example, the multimodal references may include text references that describe the objects and image references that are annotated segmentation masks of the objects. The system may generate a segmentation mask of the object within the target image with a high possibility of satisfying conditions by the references.

The system may use a similarity of embeddings between positions in the labeled images and the references. In some embodiments, the positions are the k positions with the highest probability of satisfying conditions by the references. In some embodiments, the confidence of the pixels is ranked across the multimodal references and used to identify a final set of pixels that have a confidence above a threshold. In some embodiments, the segmentation mask may be refined by inputting the positions into a segmentation model, which is trained with a large segmentation dataset and computes precise masks from object positions in images.

The positions of pixels labeled by the text reference and the positions of the pixels labeled by the image reference are computed independently and merged by taking their union. For example, the positions (e.g., pixels, groups of pixels, areas, etc.) may be merged based on distances among the positions. As another example, the selected positions may be randomized according to a probabilistic distribution. As another example, the embedding of the references may be weighted and averaged over multiple different references.

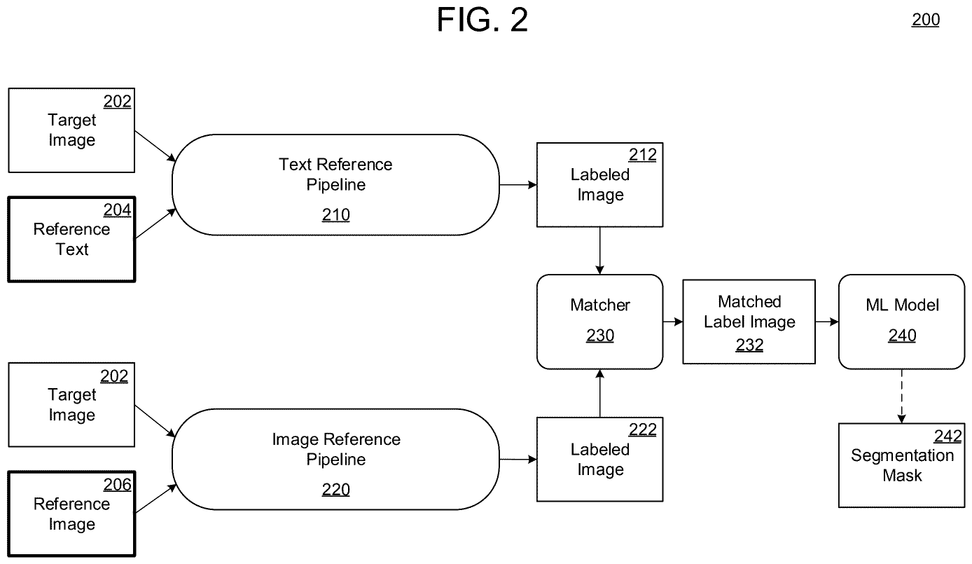

FIG. 2 illustrates a parallel pipeline architecture 200 of a text-guided few-shot semantic (FSS) image segmentation process according to an embodiment of the instant solution. For example, the parallel pipeline architecture 200 may be coded within a software application and hosted by a host platform such as a cloud platform, a web server, or the like. A user of the system may access the software application over a network, for example, by inputting an IP address of the software application into a browser of a computing device. As another example, the software application may be an on-premises software application installed locally on the computing device.

Referring to FIG. 2, the parallel pipeline architecture 200 includes a text reference pipeline 210 in parallel with an image reference pipeline 220. Here, the text reference pipeline 210 may identify an object within a target image 202 and label pixels or positions within the target image 202 that correspond to the object based on a reference text 204. The output of the text reference pipeline 210 is a labeled image 212. For example, the target image 202 may be an image that is unknown or unseen by the system. The reference text 204 may include a description of the object that is to be masked within the target image.

As an example, the target image 202 may include a picture of a boat. The reference text 204 may include a description of the object, for example, “a boat”. The text reference pipeline 210 may use a neural network to embed the target image 202 into an embedding space and to embed the reference text 204 into the same embedding space. Here, the neural network may be a multi-modal neural network that understands a relationship between text and images. The resulting embeddings may be analyzed to identify a set of matching pixels or positions within the target image 202 and label the target image 202 to generate the labeled image 212.

Furthermore, the parallel pipeline architecture 200 also includes the image reference pipeline 220 in parallel with the text reference pipeline 210. Here, the image reference pipeline 220 may identify an object within the target image 202 and label pixels or positions within the target image 202 that correspond to the object based on a reference image 206. The output of the image reference pipeline 220 is an additional labeled image 222. Here, the target image 202 is the same image used by the text reference pipeline 210. Meanwhile, the reference text 204 is not used. Instead, a reference image 206 of the object is input.

The reference image may include a picture of the object from a different image. In the example of the boat, the reference image 206 may include a picture of a boat, e.g., a picture of a different boat than is shown in the target image 202 or a picture of the same boat that is shown in the target image 202 but from a different viewpoint, a different scale, or in a different environment. The image reference pipeline 220 may use a neural network to embed the target image 202 into an embedding space and to embed the reference image 206 into the same embedding space. The resulting embeddings may be analyzed to identify a set of matching pixels or positions within the target image 202 and label the target image 202 to generate the additional labeled image 222.

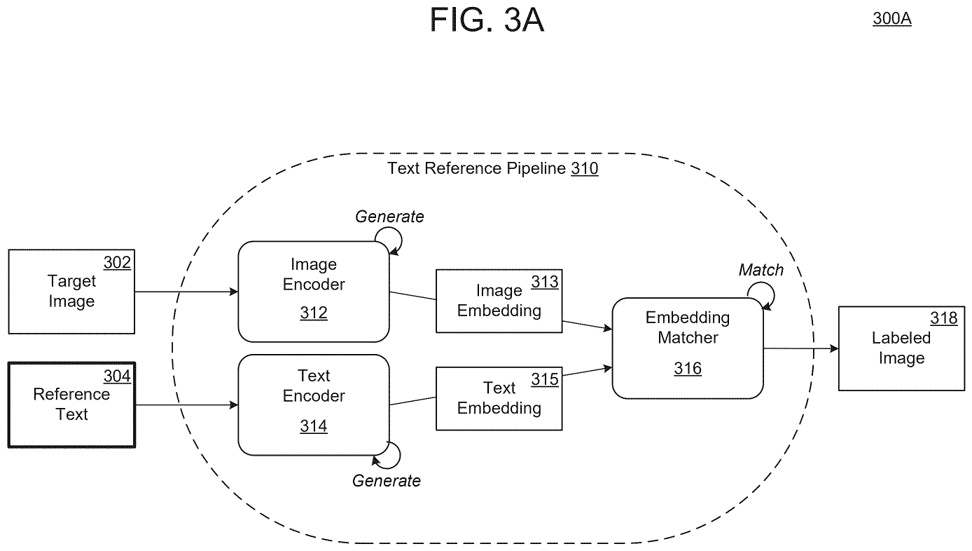

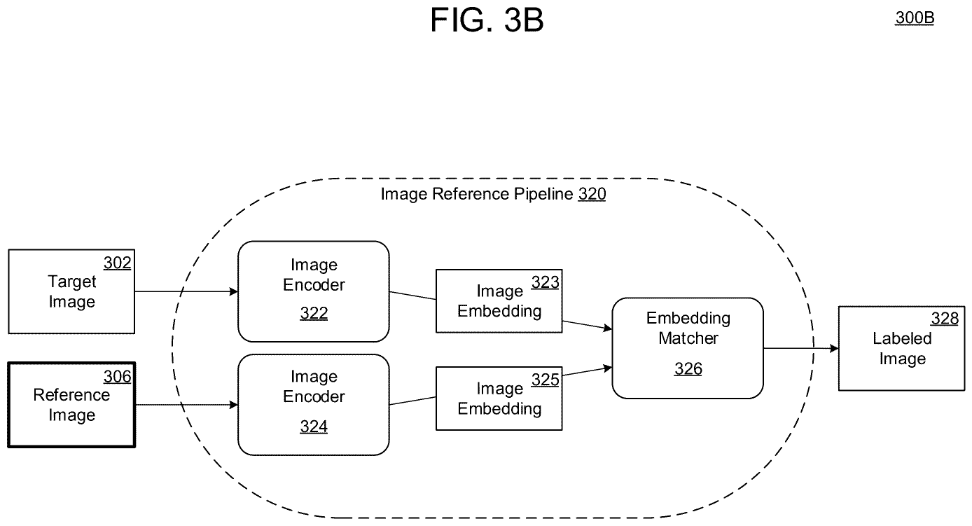

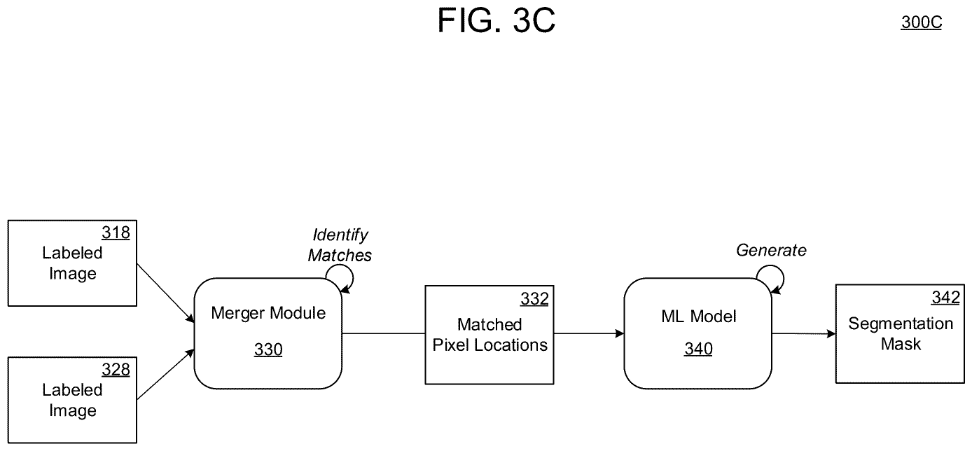

Feature matching 230 occurs in at least some embodiments in a stage in which the labeled image 212 from the text reference pipeline 210 and the additional labeled image 222 from the image reference pipeline 220 are received. The feature matching 230 identifies a final set of pixels within the target image that correspond to the object. Here, the feature matching 230 may use various methods for merging the labeled image 212 and the additional labeled image 222. Examples of the merging methods are described with respect to FIG. 3C. In at least some embodiments, the output of the feature matching 230 is a prompt, which includes matched pixels or a matched labeled image 232.

The matched labeled image 232 may be provided as input to a machine learning (ML) model 240, such as a segmentation model that can generate a segmentation mask 242 from the labeled data. Here, the segmentation mask 242 may include a mask of the object within the target image 202. The segmentation mask 242 may include labels added to each pixel in the target image. Each label indicates respectively to which portion of the target image that a respective pixel belongs.

FIG. 3A illustrates a process 300A of a text reference pipeline 310 generating a labeled image 318 according to an embodiment of the instant solution. The text reference pipeline 310 illustrated in the example of FIG. 3A may correspond to the text reference pipeline 210 shown in FIG. 2. Referring to FIG. 3A, the text reference pipeline 310 includes an image encoder 312, a text encoder 314, and a subsequent stage in which embedding matching 316 occurs. Here, the image encoder 312 may be a neural network that can convert an image into an embedding (e.g., in vector space, etc.). The text encoder 314 may include a neural network that can convert a textual description into an embedding within the same embedding space or vector space as the image encoder 312. In some embodiments, the text encoder 314 includes an LSeg architecture.

The image encoder 312 may receive a target image 302 that is to be segmented. The target image 302 may include an image of one or more objects. The image encoder 312 may convert the content within the target image 302 into an image embedding 313. Meanwhile, the text encoder 314 may receive a reference text 304, which describes the object of interest. In response, the text encoder 314 may generate a text embedding 315 of the text description in the reference text 304. The image embedding 313 and the text embedding 315 may be input to a subsequent stage for embedding matching 316 in which points or pixels of the object, within the target image from the image embedding 313 and the text embedding 315, are identified and the target image 302 is labelled with the identified/labeled pixels to generate a labeled image 318.

For example, in the embedding matching 316 the target and reference image embeddings may be received. The received embeddings may have proportional size to the original images. The embedding matching 316 may include selection of n embedding points from the text embedding 315, which are inside the mask. For each of these n points, the system may approximately infer a cosine similarity with all embedding points from the target embedding efficiently by using an optimal transport approach. The embedding matching 316 may include the summation and normalization of the similarity into one distribution that is used to select relevant embeddings, which are associated with coordinates of the object within the target image and may further include the labelling of the coordinates within the target image.

For example, the matched points may be grouped into matched positions using a k-means algorithm, or the like. Each pixel of the target image may be associated with a probability, which is computed during the embedding matching. For each matched position, the confidence of every 2D point composing the matched position is evaluated and the average confidence of those points is output. The output of embedding matching 316 is a labeled image 318, which includes a list of matched positions, and a list of the average confidences associated with each position. The set of matched positions may be used as a SAM prompt.

FIG. 3B illustrates a process 300B of an image reference pipeline 320 generating a labeled image 328 according to an embodiment of the instant solution. Referring to FIG. 3B, the image reference pipeline 320 includes an image encoder 322 and an image encoder 324, and a subsequent stage in which embedding matching 326 is performed. Here, the image encoder 322 and the image encoder 324 may be a neural network that can convert an image into an embedding (e.g., in vector space, etc.).

The image encoder 322 may receive the target image 302 that is to be segmented. The target image 302 may include an image of one or more objects. The image encoder 322 may convert the content within the target image 302 into an image embedding 323. Meanwhile, the image encoder 324 may receive a reference image 306, which includes the object of interest. In response, the image encoder 324 may generate an image embedding 325 of the reference image 306. The image embedding 323 and the image embedding 325 may be input to the subsequent stage for embedding matching 326 which identifies points or pixels of the object within the target image from the image embedding 323 and the image embedding 325, and labels the target image 302 with the identified or labeled pixels to generate a labeled image 328.

The process 300B of an image reference pipeline 320 uses the reference image 306 that is annotated, e.g., includes or is received with an annotated segmentation mask in which various pixels and/or positions of the reference image 306 are labeled as belonging to the reference object or not. For example, the reference image 306 shows a second boat which is different from the first boat shown in the target image 302 and the reference image 306 is provided with information indicating which positions and/or pixels of the reference image 306 depict the second boat (instead of the background or some other element). For the point matching, the pipeline 320 leverages this annotated information of what a boat looks like (the second boat) to help recognize the first boat in the target image 302.

For the image pipeline 320, in various embodiments both target and reference images are turned into embeddings using an image encoder. The image pipeline 320 applies one, more, or all of the following features to perform the embedding matching. For example, for a RGB image of size (H, W, 3), an embedding tensor of size (d, \tilde{H}, \tilde{W}) is used. For the DINOv2 encoder used in some embodiments, the d=1024. For the embedding matching, in various embodiments the target and reference image embeddings have proportional size to the original images: each patch from the original images is associated with an embedding value. n embedding points from the reference embedding which are inside the mask are selected. For each of these n points, the softmaxed cosine similarity with all embedding points is approximately inferred from the target embedding efficiently by using an optimal transport approach. The similarity is summed and normalized into one distribution that is used to select relevant embeddings, which are associated with coordinates from the target image. The matched points are grouped into matched positions using a k-means++ algorithm or Mean-Shift. Each pixel of the target image is associated with a probability which is computed during the embedding matching. For each matched position, the confidence of every 2D point composing the position is evaluated and the average confidence is output. The output of embedding matching is a list of matched positions and a list of the average confidences associated with each position. The set of matched positions will be used as a segmentation prompt.

For the image pipeline 320, in the matching 316 various techniques are used such as correspondence matrix extraction with cosine similarity comparison, extraction of patch-level features, analysis of patch-wise similarity, bidirectional patch matching using bipartite matching and a forward correspondence matrix and a reverse correspondence matrix and filtering if points are not in both the forward and reverse sets, a diverse prompt sampler based on clustering with k-means++, and part-level prompts, instance-level prompts, or global prompts, and controllable masks generation.

FIG. 3C illustrates a process 300C of identifying a group of pixels in the labeled images output by the text reference and image reference pipelines 310, 320 according to an embodiment of the instant solution. The process of matching pixels from the labeled image 318 and the labeled image 328 may be referred to as “merging” the labeled pixels from both images to generate a final set of labeled pixels that are fed as input (e.g., via a prompt, etc.) to a machine learning model 340, such as a segmentation model. In the example of FIG. 3C, a merger module 330 may receive the labeled image 318 output by the text reference pipeline 310 and the labeled image 328 output by the image reference pipeline 320, and identify a set of matched pixel locations 332 corresponding to the object being masked.

The merging process performed by the merger module 330 may identify a union of pixels from both the labeled image 318 and the labeled image 328 that are added to the matched pixel locations 332. There are different processes for merging the two sets of labeled pixels. Furthermore, not all labeled pixels of the object may be used from either the labeled image 318 or the labeled image 328.

As one example, the merger module 330 may merge the labeled pixels according to their matching confidence scores. The confidence scores may be ranked, thereby ranking the labeled pixels across both the labeled image 318 and the labeled image 328. For example, all of the pixels may be combined into a pool and ranked using their confidence scores. The confidence scores may be compared to a threshold confidence value. The merger module 330 may select pixels that have a confidence value above the threshold confidence value for inclusion in the matched pixel locations 332. Considering all matched positions regardless of the pipeline from which they were output, the merger module 330 may rank them by decreasing confidence and keep the top k positions with highest confidence.

As another example, the merger module 330 may use a nearest neighbor merging process. For each labeled pixel included in the labeled image 318, the merger module may look for corresponding labeled pixels within the labeled image 328. If a pixel in the labeled image 318 is within a pre-determined distance α from a pixel in the labeled image 328, the merger module 330 may concatenate the two pixels to form a single pixel within the matched pixel locations 332. Through this process, the merger module 330 may remove positions from labeled image 318, which are not close enough to a position from the labeled image 328, and/or vice versa, thereby reducing the total number of pixels added to the matched pixel locations 332. It is also possible to use this method by reverting the roles of the labeled image 318 and the labeled image 328. Thus, for this terminology either the labeled image 318 or the labeled image 328 is used as a base set, with the positions of the other set (that is not the base set) being added into the base set, concatenated into a position of the base set, and/or removed and not used in a final set.

It is also possible for the merger module 330 to use other position merging techniques (e.g. random sampling, removing “redundant” similar matched points, etc.). The merger module 330 may output one mask per pipeline and then merge them instead of merging the matched embedding points. As another example, the merger module 330 may merge all matched points from the embedding matching (before they are clustered into matched positions). As another example, the merger module 330 may merge the text and image reference embeddings (by averaging for example) and then perform only one embedding matching between the target image embedding and the newly obtained embedding.

The machine learning model 340 may receive the matched pixel locations 332 and perform image segmentation to generate the segmentation mask 342 for the target image 302. The segmentation model may accept a variety of prompts to perform image segmentation.

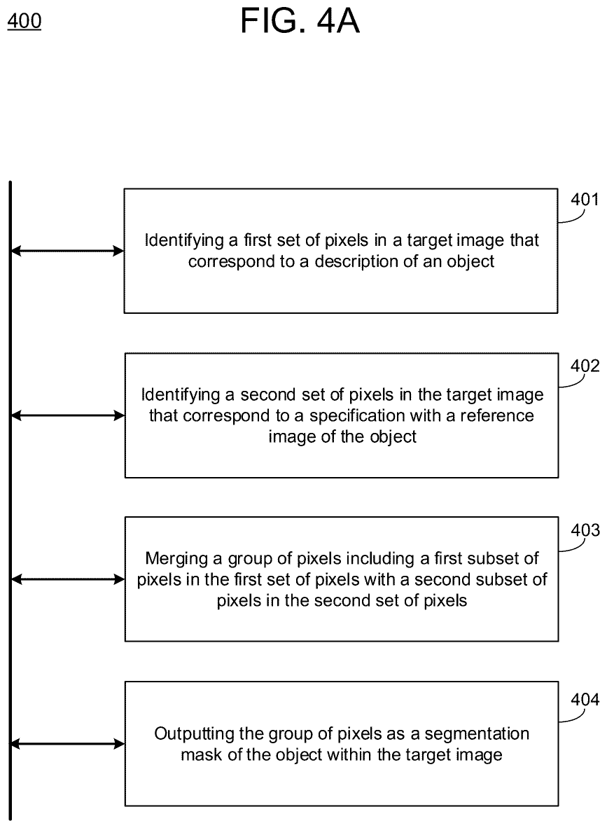

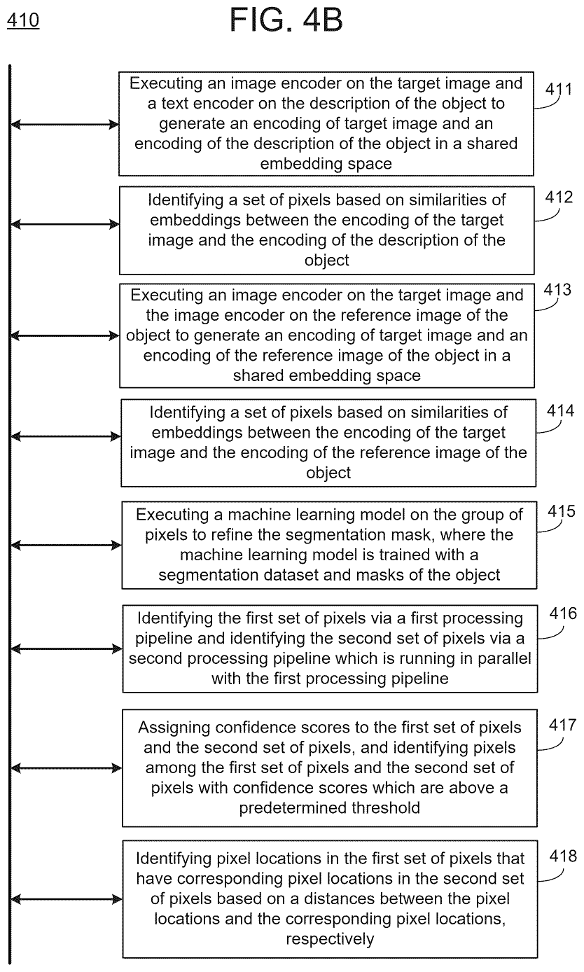

FIG. 4A illustrates a flow diagram of a method 400, according to example embodiments. Referring to FIG. 4A, in 401, the method may include identifying a set of positions of a target image that correspond to an object to be identified within the target image, the identifying of the set of positions occurring via matching first embeddings of the target image to additional embeddings from a description of the object and from a reference image of a reference object. In 402, the method may include producing a segmentation prompt from the set of positions. In 403, the method may include inputting the segmentation prompt into an image segmentation model so that, in response, the image segmentation model generates as an output a segmentation mask for the object and for the target image.

FIG. 4B illustrates a flow diagram of a method 410, according to example embodiments. Referring to FIG. 4B, in 411, the method may include identifying a first set of positions of the target image that correspond to the description of the object, the identifying of the first set occurring via matching first embeddings of the target image to second embeddings of the description, identifying a second set of positions of the target image that correspond to the reference object of the reference image, the identifying of the second set occurring via matching third embeddings of the target image to fourth embeddings of the reference image, and merging the first set of the positions and the second set of the positions to produce the set of positions. In 412, the identifying of the first set of positions occurs via a first processing pipeline and the identifying of the second set of positions occurs via a second processing pipeline which runs in parallel with the first processing pipeline.

In 413, a processing output of the first processing pipeline is a first mask corresponding to the first set of the positions, a second processing output of the second processing pipeline is a second mask corresponding to the second set of positions, the merging includes merging the first mask to the second mask to produce the segmentation mask, and the producing the segmentation prompt and the inputting the segmentation prompt into the image segmentation model occurs respectively within the first processing pipeline and within the second processing pipeline. In 414, the merging is based on a nearest neighbor analysis of the first set of positions and the second set of positions.

In 415, the nearest neighbor analysis includes concatenating each position of the first set or the second set into another position of the other of the first set and the second set in response to a distance between the two positions being less than a pre-determined distance. In 416, the nearest neighbor analysis includes removing a respective position from one of the first set and the second set in response the respective position not being withing a pre-determined distance from any position of the other of the first set and the second set. In 417, one of the first set and the second set is used as a base set for the nearest neighbor analysis.

FIG. 4C illustrates a flow diagram of a method 420, according to example embodiments. Referring to FIG. 4B, in 421, the method may include inputting the target image into an image encoder to generate the first embeddings of the target image, inputting the description into a text encoder to generate embeddings of the description that are part of the additional embeddings, inputting the reference image into the image encoder to generate embeddings of the reference image that are part of the additional embeddings, where the image encoder and the text encoder produce output into a shared embedding space. In 422, the matching of the first embeddings of the target image to the additional embeddings of the description is based on similarities of the first embeddings of the target image to the additional embeddings.

In 423, the method may include assigning confidence scores to positions of the target image, respectively, based on a respective confidence that a respective position matches at least one of the description and the reference object, and selecting a subset of positions for the set of positions due to the confidence scores of the subset of positions exceeding one or more predetermined threshold values. In 424, the method may include assigning confidence scores to positions of the target image as matching the description and the reference object, respectively, ranking the positions based on a descending order of the confidence scores, and selecting a subset of positions for the set of positions, wherein how many are selected is based on a predetermined number, and the subset of positions that are selected have highest confidences scores among the set of positions.

In 425, the method may include assigning confidence scores to positions of the target image as matching the description and the reference object, respectively, ranking the positions based on a descending order of the confidence scores, and selecting a subset of positions for the set of positions, wherein how many are selected is based on a predetermined number, and the subset of positions that are selected have highest confidences scores among the set of positions. In 426, the method may include merging all matched points from the matching of the first embeddings to the additional embeddings, and subsequent to the merging of all matched points, clustering the merged points into clusters to form the set of positions. In 427, the method may include merging second embeddings from the description of the object and third embeddings from the reference image of the reference object to form the additional embeddings, and subsequent to the merging, performing the matching of the first embeddings to the additional embeddings to produce the set of positions of the target image that correspond to the object to be identified.

Detailed descriptions of training a machine learning model and executing a machine learning model are further described and depicted herein.

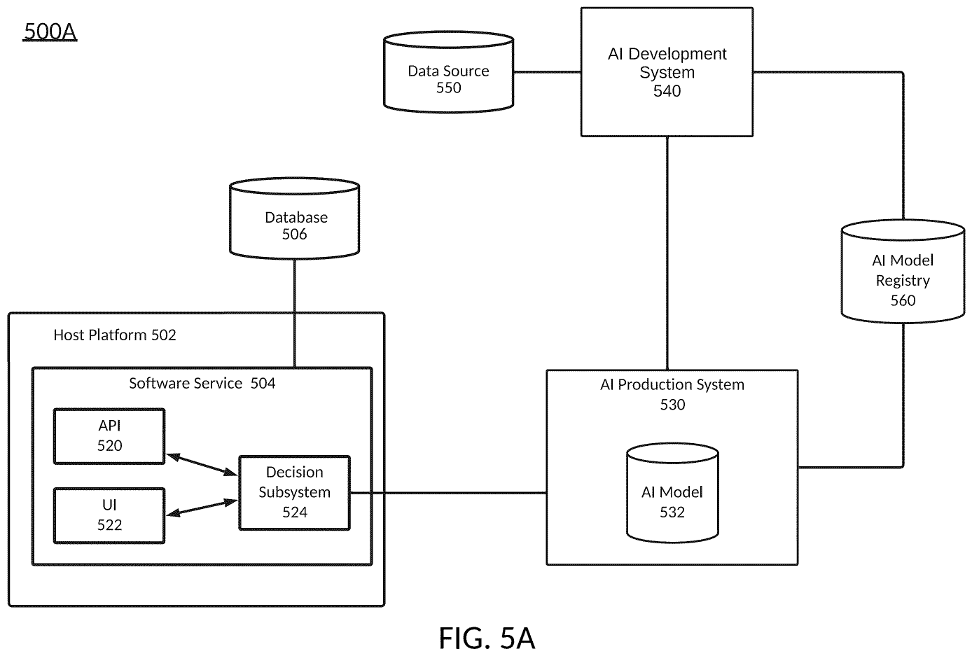

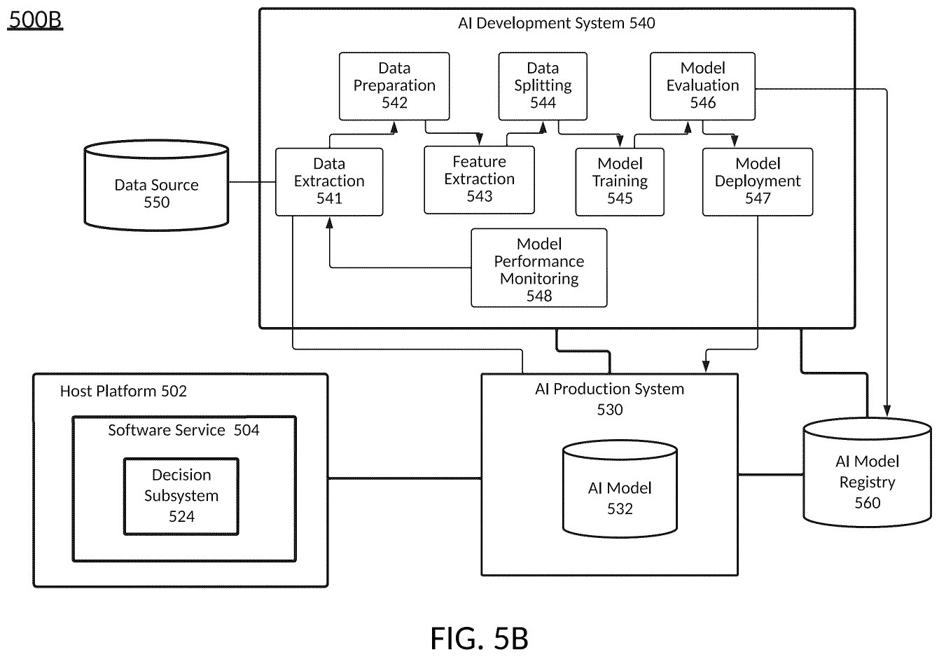

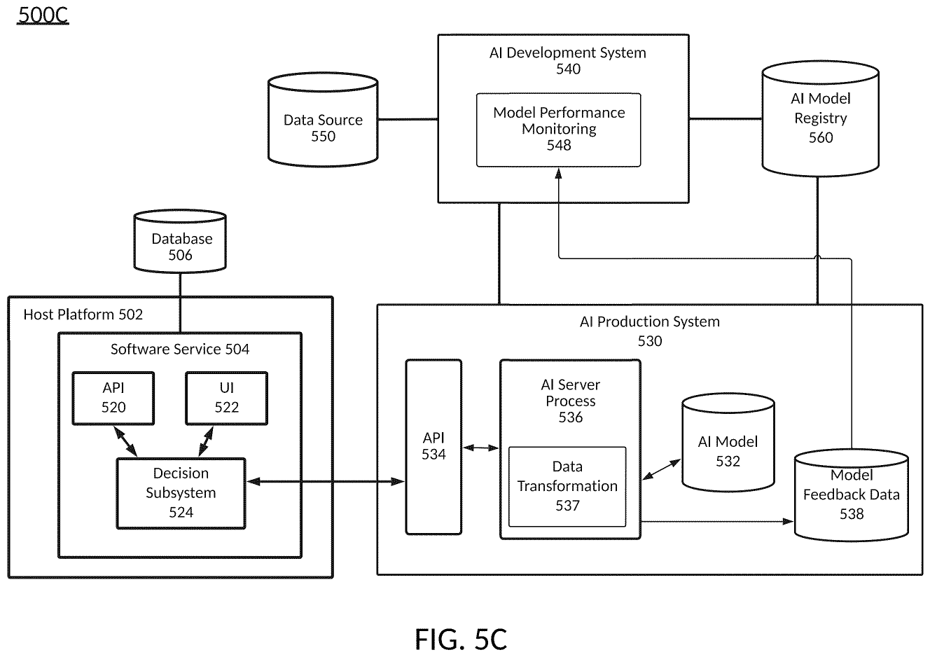

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content - such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks. Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities. Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A). Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method (CIM) comprising:
identifying a set of positions of a target image that correspond to an object to be identified within the target image, the identifying of the set of positions occurring via matching first embeddings of the target image to additional embeddings from a description of the object and from a reference image of a reference object;
producing a segmentation prompt from the set of positions; and
inputting the segmentation prompt into an image segmentation model so that, in response, the image segmentation model generates as an output a segmentation mask for the object and for the target image.

2. The CIM of claim 1, wherein the identifying the set of positions comprises:
identifying a first set of positions of the target image that correspond to the description of the object, the identifying of the first set occurring via matching first embeddings of the target image to second embeddings of the description;
identifying a second set of positions of the target image that correspond to the reference object of the reference image, the identifying of the second set occurring via matching third embeddings of the target image to fourth embeddings of the reference image; and
merging the first set of the positions and the second set of the positions to produce the set of positions.

3. The CIM of claim 2, wherein the identifying of the first set of positions occurs via a first processing pipeline and the identifying of the second set of positions occurs via a second processing pipeline which runs in parallel with the first processing pipeline.

4. The CIM of claim 3, wherein a processing output of the first processing pipeline is a first mask corresponding to the first set of the positions, wherein a second processing output of the second processing pipeline is a second mask corresponding to the second set of positions, wherein the merging comprises merging the first mask to the second mask to produce the segmentation mask, and wherein the producing the segmentation prompt and the inputting the segmentation prompt into the image segmentation model occurs respectively within the first processing pipeline and within the second processing pipeline.

5. The CIM of claim 2, wherein the merging is based on a nearest neighbor analysis of the first set of positions and the second set of positions.

6. The CIM of claim 5, wherein the nearest neighbor analysis comprises concatenating each position of the first set or the second set into another position of the other of the first set and the second set in response to a distance between the two positions being less than a pre-determined distance.

7. The CIM of claim 5, wherein the nearest neighbor analysis comprises removing a respective position from one of the first set and the second set in response the respective position not being withing a pre-determined distance from any position of the other of the first set and the second set.

8. The CIM of claim 5, wherein one of the first set and the second set is used as a base set for the nearest neighbor analysis.

9. The CIM of claim 1, further comprising:
inputting the target image into an image encoder to generate the first embeddings of the target image;
inputting the description into a text encoder to generate embeddings of the description that are part of the additional embeddings;
inputting the reference image into the image encoder to generate embeddings of the reference image that are part of the additional embeddings;
wherein the image encoder and the text encoder produce output into a shared embedding space.

10. The CIM of claim 1, wherein the matching of the first embeddings of the target image to the additional embeddings of the description is based on similarities of the first embeddings of the target image to the additional embeddings.

11. The CIM of claim 1, wherein the identifying the set of positions further comprises:
assigning confidence scores to positions of the target image, respectively, based on a respective confidence that a respective position matches at least one of the description and the reference object; and
selecting a subset of positions for the set of positions due to the confidence scores of the subset of positions exceeding one or more predetermined threshold values.

12. The CIM of claim 1, wherein the identifying the set of positions further comprises:
assigning confidence scores to positions of the target image as matching the description and the reference object, respectively;
ranking the positions based on a descending order of the confidence scores; and
selecting a subset of positions for the set of positions, wherein how many are selected is based on a predetermined number, and the subset of positions that are selected have highest confidences scores among the set of positions.

13. The CIM of claim 1, wherein the identifying the set of positions further comprises:
assigning confidence scores to positions of the target image as matching the description and the reference object, respectively;
ranking the positions based on a descending order of the confidence scores; and
selecting a subset of positions for the set of positions, wherein how many are selected is based on a predetermined number, and the subset of positions that are selected have highest confidences scores among the set of positions.

14. The CIM of claim 1, wherein the identifying the set of positions comprises:
merging all matched points from the matching of the first embeddings to the additional embeddings; and
subsequent to the merging of all matched points, clustering the merged points into clusters to form the set of positions.

15. The CIM of claim 1, wherein the identifying the set of positions comprises:
merging second embeddings from the description of the object and third embeddings from the reference image of the reference object to form the additional embeddings, and
subsequent to the merging, performing the matching of the first embeddings to the additional embeddings to produce the set of positions of the target image that correspond to the object to be identified.

16. A computer system comprising:
a processor set;
a set of one or more computer-readable storage media; and
program instructions, collectively stored in the set of one or more storage media, that cause the processor set to perform computer operations comprising:
identifying a set of positions of a target image that correspond to an object to be identified within the target image, the identifying of the set of positions occurring via matching first embeddings of the target image to additional embeddings from a description of the object and from a reference image of a reference object;
producing a segmentation prompt from the set of positions; and
inputting the segmentation prompt into an image segmentation model so that, in response, the image segmentation model generates as an output a segmentation mask for the object and for the target image.

17. The computer system of claim 16, wherein the computer operations further comprise assigning confidence scores to positions of the target image, respectively, based on a respective confidence that a respective position matches at least one of the description and the reference object, and selecting a subset of positions for the set of positions due to the confidence scores of the subset of positions exceeding one or more predetermined threshold values.

18. The computer system of claim 16, wherein the computer operations further comprise assigning confidence scores to positions of the target image as matching the description and the reference object, respectively, ranking the positions based on a descending order of the confidence scores, and selecting a subset of positions for the set of positions, wherein how many are selected is based on a predetermined number, and the subset of positions that are selected have highest confidences scores among the set of positions.

19. The computer system of claim 16, wherein the computer operations further comprise merging all matched points from the matching of the first embeddings to the additional embeddings, and subsequent to the merging of all matched points, clustering the merged points into clusters to form the set of positions.

20. A computer program product comprising:
a set of one or more computer-readable storage media; and
program instructions, collectively stored in the set of one or more computer-readable storage media, for causing a processor set to perform computer operations comprising:
identifying a set of positions of a target image that correspond to an object to be identified within the target image, the identifying of the set of positions occurring via matching first embeddings of the target image to additional embeddings from a description of the object and from a reference image of a reference object;
producing a segmentation prompt from the set of positions; and
inputting the segmentation prompt into an image segmentation model so that, in response, the image segmentation model generates as an output a segmentation mask for the object and for the target image.
